(19) United States
(12) Patent Application Publication
(10) Pub. No.: US 2011/0170377 A1
(43) Pub. Date: Jul. 14, 2011

(54) SYSTEMS AND METHODS FOR AUTOMATICALLY DISABLING APPLIANCES

(76) Inventor: Ferdinand Villegas Legaspi, Chino, CA (US)

(21) Appl. No.: 12/891,777

(22) Filed: Sep. 27, 2010

Related U.S. Application Data
(63) Continuation-in-part of application No. 12/660,402, filed on Feb. 26, 2010, now abandoned.
(60) Provisional application No. 61/341,993, filed on Apr. 8, 2010.
(60) Provisional application No. 61/335,738, filed on Jan. 12, 2010.

(51) Int. Cl. G10K 15/00

(52) U.S. Cl. 367/199

(57) ABSTRACT

A system for automatically disabling one or more appliances is provided. The system may include one or more detectors that are configured to emit a signal upon an occurrence of an event, such as a fire, which may be an early indication of a developing emergency. The signal may be in the form of an audible alert, such as sound (or sound waves). A receiver module may receive a plurality of the sound waves and analyze the plurality of sound waves for a variation in frequency to determine if any of the sound waves originate from the one or more detectors. Upon the determination of sound waves originating from a detector, a valve member, connected between an energy source and an appliance, may disconnect the energy source from the one or more appliances disabling the one or more appliance reducing damage caused by the event.

### CLAIM OF PRIORITY

This non-provisional United States (U.S.) Patent Application is a continuation-in-part application of, and claims priority on, non-provisional U.S. patent application Ser. No. 12/660,402 entitled “Wireless Smoke Detector Alarm with Automatic Gas Shutdown Valve”, filed on Feb. 26, 2010, the contents of which is hereby incorporated by reference, which claims priority to U.S. Provisional Application No. 61/341,993 entitled “Cooking Appliance with Smoke Alarm, Vibration Detector, Circuit Breaker and Flood Control Switch”, filed Apr. 8, 2010 and U.S. Provisional Application No. 61/335,738 entitled “Wireless Smoke Detector Alarm with Automatic Gas Shutdown Valve”, filed Jan. 12, 2010, the contents of which are hereby expressly incorporated by reference herein.

### FIELD

The present invention relates to the field of automated safety capabilities for appliances or other devices, in particular, to systems and methods for automatically disabling appliances or other devices upon the occurrence of a safety event.

### BACKGROUND OF THE INVENTION

A large number of residential and commercial fires could be prevented if stopped from proliferating during their early stages. Many of these residential and commercial fires originate in the kitchen as overheated cooking oils or greases during cooking can easily ignite which result in potentially dangerous fires leading to the production of smoke and fire. Within minutes of bursting into flames, a fire may consume the contents, walls and ceiling of the room where the fire started and the combination of heat, smoke and carbon monoxide can kill everyone in the area.

Furthermore, in commercial eating establishments, fires from cooking devices can be devastating, often causing cessation of normal business activities for days or weeks, and sometimes permanently. Due to the nature of cooking, the threat of a fire is always present. Having the means to prevent and/or detect a fire in and around a cooking device before the fire has a chance to spread is essential to saving lives and limiting damage.

As these types of fires proliferate when they are unattended, it is important to extinguish or suppress these fires quickly. Generally smoke detectors are used to detect the fires and issue an audible and/or visual alarm to alert individuals in the vicinity that a fire is present, allowing for actions to be taken to extinguish the fire. However, if no one is around to hear and/or see the alarm, the fire will continue to burn causing significant damage.

Another possible cause of a fire is the danger of a gas explosion as a result from gas leaking from broken gas pipes following an earthquake. Sometimes the damage caused by the earthquake may not appear significant, but if the gas accumulates and explodes due to the gas leak, the damage could be catastrophic and life threatening.

One way to reduce damage caused by a fire and the risk of post-earthquake damage is to shut off the source of energy, such as electricity and/or gas, to the appliance, or other device, where the fire started. However, if no one is around, the source of energy cannot be shut off. Although devices exist to shut off a gas line in the event of an earthquake, a system and/or device does not exist for automatically turning off an energy source, such as electricity and/or gas, upon the detection of an audible alert from detectors, such as smoke detectors, gas detectors for detecting carbon monoxide gas, natural gas, propane, and other toxic gas, fire detectors, flame detectors, heat detectors, infra-red sensors and ultra-violet sensors.

Consequently, a system and device for shutting off an energy source, such as electricity or gas, to appliances or other devices upon the detection of an audible alert is needed.

### SUMMARY

One feature of the present invention provides a system for automatically disabling one or more appliances. The system may include one or more detectors (or detector modules) that are configured to emit a signal upon an occurrence of an event, such as a fire, which may be an early indication of a developing emergency. The signal may be in the form of an audible alert, such as sound (or sound waves). A receiver module may receive a plurality of the sound waves and analyze the plurality of sound waves for a variation in frequency (or Doppler Effect) to determine if any of the sound waves originate from the one or more detectors. As sound waves emanating from detectors have the characteristics of a stationary high frequency, it is known that sound waves having a variation in frequency are not emanating from the detectors. Upon the determination of sound waves originating from a detector, a valve member, connected between an energy source and an appliance (or other device), may disconnect the energy source from the appliance (or other device) disabling the appliance (or other device) reducing damage caused by the event.

In one aspect, the receiver module may include a microphone for receiving the plurality sound waves from one or more detectors (or other sources), a variable resistor which generates a plurality of constant sound waves from the plurality of sound waves, an amplifier which amplifies the plurality of constant sound waves, a transistor for receiving the amplified plurality of constant sound waves and a relay connected between the transistor and a power source for supplying power to the relay. The relay may control movement of the valve member between a first position (allowing energy to flow to an appliance) and a second position (interrupting the flow of energy to an appliance). The transistor may be used to determine stable frequency and control power to the relay which in turn controls the position of the valve member. Upon the detection of stationary high pitch stable sound waves, it may be determined that the sound waves are emanating from a detector and the valve member actuates from the first position to the second position disabling the appliance. As the detector has been activated, the transistor may cut off power to the relay which in turn causes the valve member to actuate from the first position to the second position. As a result, the appliance (or other device) is disabled. If the sound waves are determined to have a Doppler Effect, the sound waves are determined to not be emanating from a detector and the valve member does not actuate to the second position and the appliance (or other device) is not disabled.

In another aspect, a motion detector may be utilized for detecting continuous movement within a pre-determined distance of the receiver module. Upon sensing movement or the presence of an individual, the receiver module may be disabled preventing the valve member from actuating from the first position to the second position. As an individual is within close range, that individual may manually shut off the flow of energy to the appliance (or device).

In yet another aspect, if any of the sound waves are determined to originate from one or more detectors, a notification message may be sent to a user notifying the user of the occurrence of an event. This notification message may be in the form of an email, text, telephone call, etc.

In yet another aspect, a central computer may be utilized to control the operation of a plurality of valve members. Upon receiving a signal from one or more receiver modules, the central computer may send a message to the corresponding valve member(s) causing the valve member(s) to actuate from a first position allowing the flow of energy to the appliances (or devices) to a second position interrupting the flow of energy to the appliances (or devices).

In yet another aspect, a user may remotely disconnect, disable or interrupt the flow of energy to one or more appliances (or devices). The central computer may be capable of receiving an access input code provided by the user via a website, via a telephone or other means. The central computer may then compare the access input code provided by the user to a list of appliance codes stored in a memory device in the central computer. If the access input code is found on the list of appliance codes, the central computer may disrupt the flow of energy to the corresponding appliance (or device) by causing the valve members associated with the access input code to actuate to a closed position disrupting energy flow to the appliances (or devices).

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1A is a block diagram illustrating a general overview of a system for disabling an appliance in response to an event, according to a first embodiment.

FIG. 1B is a block diagram illustrating a general overview of another system for disabling an appliance in response to an event, according to a second embodiment.

FIG. 2 is a block diagram illustrating a general overview of the internal structure of the detector module and controller module of FIG. 1, according to one embodiment.

FIG. 3 is a block diagram of one example of a detector, having and RF transceiver, configured to disable the flow of energy to one or more appliances, according to one embodiment.

FIG. 4 is a block diagram of one example of a detector, having an 802.11 (i.e., Wi-Fi®) transceiver, configured to disable the flow of energy to one or more appliances, according to one embodiment.

FIG. 5 is a block diagram of one example of a detector, having a Bluetooth interface, configured to disable the flow of energy to one or more appliances, according to one embodiment.

FIG. 6 is a block diagram of one example of a detector, having a wireless transceiver and remote shutoff receiver, configured to disable the flow of energy to one or more appliances, according to one embodiment.

FIG. 7 is a functional block diagram of one example of a reset switch assembly configured to reset a system, for disabling the flow of energy to appliance, after activation, according to one embodiment.

FIG. 8 illustrates one example of a valve for regulating the flow of energy to one or more appliances, according to one embodiment.

FIG. 9 illustrates one example of a vibration switch for disabling one or more appliances, according to one embodiment.

FIG. 10 illustrates one example of a flood control switch for disabling one or more appliances, according to one embodiment.

FIG. 11 is a functional block diagram of one example of a wired system for disabling the flow of energy to an appliance in response to an event, according to one embodiment.

FIG. 12 is a functional block diagram of one example of a system for remotely controlling the flow of energy to one or more appliances, according to one embodiment.

FIG. 13 is another functional diagram of a remote shut-off system for remotely controlling the flow of energy to one or more appliances, according to one embodiment.

FIG. 14 illustrates a functional block diagram of the internal structure of the telephone switch interface board of FIG. 13.

FIG. 15 is a functional block diagram of one example of a wireless sound wave valve having a reset switch, according to one embodiment.

FIG. 16 illustrates a schematic diagram of the sound wave valve of FIG. 15.

FIG. 17A illustrates a short wavelength sound wave having a high pitch or high frequency.

FIG. 17B illustrates a long wavelength sound wave having a low pitch or low frequency.

FIG. 17C illustrates a sound wave in the form of noise.

FIG. 17D illustrates a mixture of sound waves in the form of musical tones.

FIG. 17E illustrates a sound wave with a Doppler Effect.

FIG. 17F illustrates the characteristics of a stationary high frequency sound wave.

FIG. 18 illustrates a schematic diagram of a sound wave receiver having a motion detector and wireless switches, according to one embodiment.

FIG. 19 illustrates a back view of a sound wave receiver, according to one embodiment.

FIG. 20 illustrates a front view of a sound wave receiver, according to one embodiment.

FIG. 21 illustrates a front view of a wired sound wave valve, according to one embodiment.

FIG. 22 illustrates a front view of a wireless sound wave valve, according to one embodiment.

FIG. 23 illustrates a front view of the wired sound wave valve of FIG. 21.

FIG. 24 illustrates a front view of the wireless sound wave valve of FIG. 22.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may not be shown detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data. Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

In the following description, certain terminology is used to describe certain features of one or more embodiments of the invention. The term “appliance” refers to any type of electrical and/or mechanical device which accomplishes some household function, such as cooking, cleaning and entertaining. An appliance includes, but not limited to, a stove, oven, microwave, fryer, toaster, barbeque, dishwasher, clothes dryer, washing machine, freezer, refrigerator, water heater, trash compactor, air conditioner, television, radio, CD player, DVD player, video game consoles, telephones and clocks. The term “event” refers to any type of emergency or developing emergency including, but not limited to, the detection of smoke, fire, heat, carbon monoxide and gas. The terms “energy source” and “energy” refers to any source of powering an appliance or other device including, but not limited to gas and electricity. The terms “detector” and “detector module” refer a device for detecting the presence of hazardous environmental conditions, including, but not limited to, smoke, gas, carbon monoxide gas, natural gas, propane, fire, flames, and heat, as well as non-environmental hazardous conditions, such as motion.

Embodiments of the invention are directed to systems and methods for automatically disabling one or more appliances upon the occurrence of an event. The system may include one or more detectors (or detector modules) that are configured to emit a signal upon an occurrence of the event, such as a fire, which may be an early indication of a developing emergency. The signal may be in the form of an audible alert, such as sound (or sound waves).

A receiver module may receive a plurality of the sound waves and analyze the plurality of sound waves for a variation in frequency (or Doppler Effect) to determine if any of the sound waves originate from the one or more detectors. As sound waves emanating from detectors have the characteristics of a stationary high frequency, it is known that sound waves having a variation in frequency are not emanating from the detectors. Upon the determination of sound waves originating from a detector, a valve member, connected between an energy source and an appliance (or other device), may disconnect the energy source from the appliance (or other device) disabling the appliance (or other device) reducing damage caused by the event.

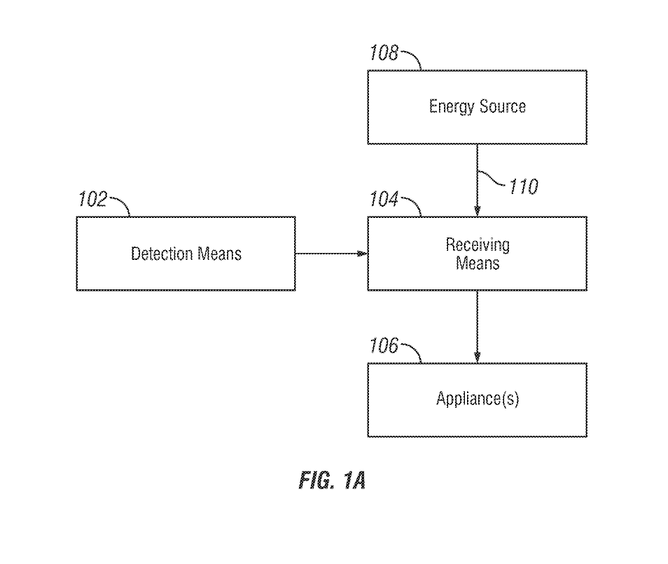

FIG. 1A is a block diagram illustrating a general overview of a system 100 for disabling an appliance in response to an event, according to a first embodiment. The event may be an early indication of a developing emergency. As shown, the system 100 may include a detector means 102, a receiver means 104 and one or more appliances 106. In one aspect, the receiver means 104 may be operatively connected to the detector means 102 and the one or more appliances 106.

The detector means 102 may be distributed at suitable locations within a building for detecting hazardous conditions throughout the building. For example, if the building is a home, the detector means (or modules) 102 can be located in the various rooms of the home, including the kitchen, the basement, the bedrooms, etc. As discussed above, the detector modules include, but are not limited to, environmental condition detectors for detecting hazardous environmental conditions, such as smoke detectors, gas detectors for detecting carbon monoxide gas, natural gas, propane, and other toxic gas, fire detectors, flame detectors, heat detectors, infra-red sensors, ultra-violet sensors, and combinations thereof. The detector means 102 can also include, but are not limited to, detectors that detect a non-environmental hazardous condition, such as motion sensors. For sake of convenience, the detector modules will hereinafter be described and referred to as smoke detectors that are configured to detect smoke. However, it is to be realized that the detector means 102 can include other forms of detectors as well.

The receiver means 104 may be connected between and an energy source 108 and the appliance 106 in, for example, a main line 110 leading from the energy source 108 to the appliance 106. During normal operation, the receiver means 104 may allow energy, for example in the form or gas or electricity, to pass or flow from the energy source 108 to the appliance 106. However, upon the occurrence of an event, the detector means 102 may transmit a signal to the receiver means 104 causing the receiver means 104 to block or interrupt the flow of energy from the energy source 108 to the appliance 106. As a result, the appliance 106 may be shut off or disabled helping to reduce or extinguish any fire.

In accordance with various aspects of the present invention, the signal may be sent from the detector means 102 to the receiver means 104 using wired or wireless signals, such as voice and/or data signals or messages. The signal may be a radio frequency (RF) signal, a pulsed signal, or a simple voltage level. Additionally, the detector means 102 may be operatively connected to multiple receiver modules, where each receiver module is operatively coupled to a different appliance.

FIG. 1B is a block diagram illustrating a general overview of a system 122 for disabling one or more appliances in response to an event, according to a second embodiment. As shown, the system 122 may include one or more detector modules 124a-124b in operative communication with one or more receiver modules 126a-126c. Each of the receiver modules 126a-126c may be operatively connected to a central computer 128 which is in operative communication with one or more valve members 130a-130c which regulate the flow of energy, from one or more energy sources 134 to one or more appliances 132a-132c.

The central computer 128 may include a processing circuit 136 (e.g., processor, processing module, etc.) coupled to a communication interface 138, such as a receiver or transceiver, to communicate over a wired or wireless network with the receiver modules 126a-126c and a memory device 140 to store codes associated with each appliance allowing the user to turn off a specific appliance or multiple appliances remotely, as discussed below in further detail.

During normal operation, the central computer 128 may allow energy, for example in the form of gas or electricity, to pass or flow from the energy source 134 to the appliances 132a-132c. However, upon the occurrence of an event, the one or more detector modules 124a-124b may transmit a signal to the central computer 128, via the one or more receiver modules 126a-126c, causing the central computer 128 to send a message to the valve members 130a-130c causing the valve members 130a-130c to actuate from a first position to a second positions, as described below in further detail, to block the flow of energy from the energy source 134 to the appliances 132a-132c. As a result, the appliances 132a-132c may be shut off or disabled helping to reduce or extinguish any fire.

In accordance with various aspects of the present invention, the signal may be sent from the one or more detector modules 126a-126c to the central computer 128 using wired or wireless signals, such as voice and/or data signals or messages. The signal may be a radio frequency (RF) signal, a pulsed signal, or a simple voltage level.

In accordance with one aspect, upon the detection of an event, the central computer may send a notification message to a user notifying the user of a potential problem. The notification may be in the form or a text, email, telephone or any other method of communication known in the art.

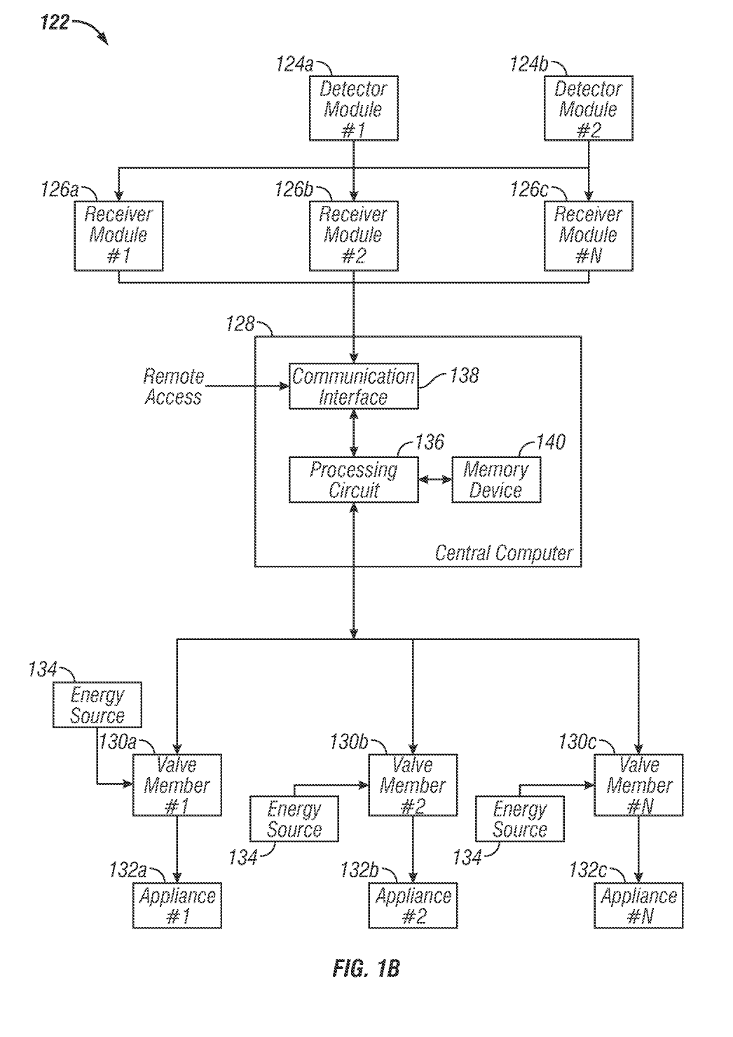

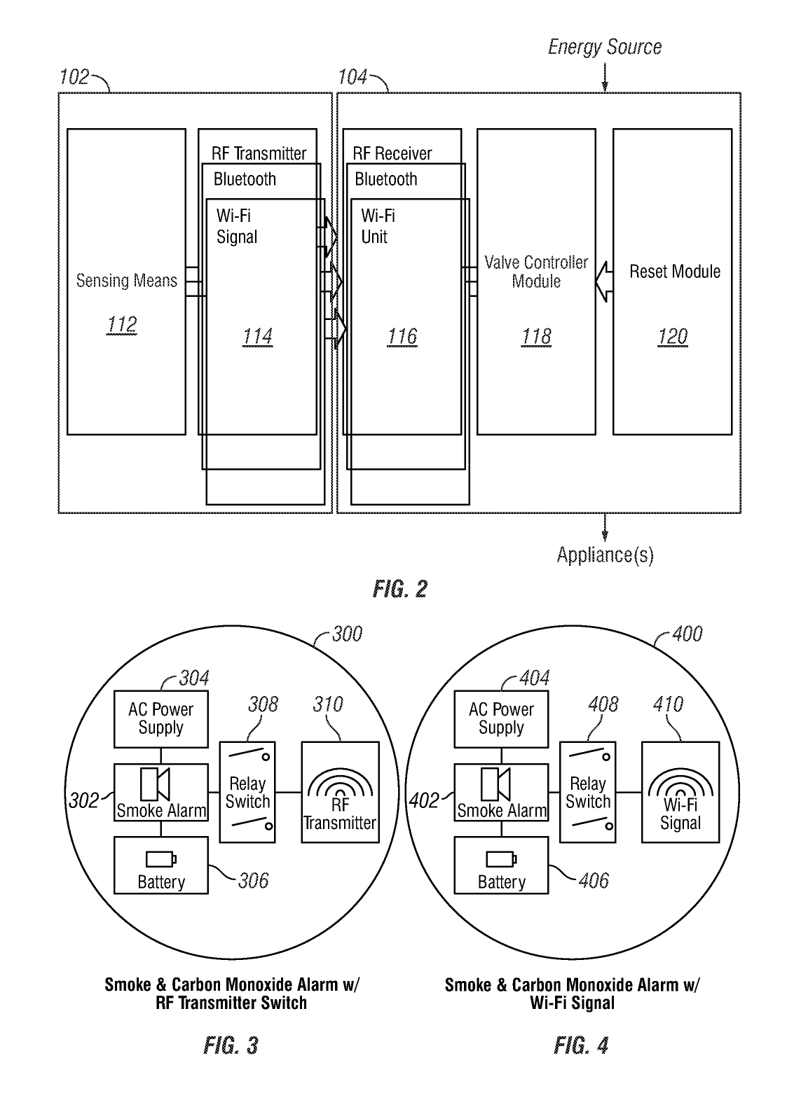

FIG. 2 is a block diagram illustrating a general overview of the internal structure of the detector means and receiver means of FIG. 1, according to one embodiment. The detector means 102 may include a sensing means 112 configured to detect a hazardous situation and a first communication interface 114 configured to communicate information between the detector means 102 and the receiver means 104. The receiver means 104 may include a second communication interface 116, a valve controller module 118 and a reset module 120.

The first and second communication interfaces 114, 116 may be implemented using any type of suitable wired or wireless transmitter, receiver, or transceiver such as, for example, a Bluetooth® transceiver, an 802.11 (i.e., Wi-Fi®) transceiver, a Radio Frequency (RF) transceiver, a cellular communications transceiver, an optical communications transceiver, etc.

The valve controller module 118 may be in communication with one or more appliances. Upon the detection of an event, a signal may be sent to the valve controller module 118 causing the module 118 to disable an energy source connected to the one or more appliances. The reset module 120 may be operatively coupled to the valve controller unit 120 and configured to reset the valve controller module 118 after a triggering event.

FIGS. 3-6 illustrate block diagrams of various detectors (or detector modules) utilizing different modes of communication for disabling or disconnecting the flow of energy to an appliance or other device. FIG. 3 is a block diagram of one example of a detector module 300, having an RF transceiver, and configured to disable the flow of energy to one or more appliances. As shown, the detector module 300 may include a smoke sensor 302, powered by either an AC power source 304 or a battery 306, and a relay/switch 308. Upon the smoke sensor 302 sensing or detecting smoke or products of combustion, the relay/switch 308 may be moveable from an open position in which power is disconnected to an RF transmitter 310 to a closed position supplying power to the RF transmitter 310. In other words, when smoke or products of combustion are not being detected, the relay 308 may be in an open position so that power is not provided to the RF transmitter 310 and as a result, the RF transmitter 310 is not transmitting a signal to a receiver on a valve controller unit (or valve member) which controls the flow of energy to an appliance or other device. Conversely, when smoke or products of combustion are being detected, the relay 308 may be in a closed position providing power to the receiver which in turn, as discussed above, causes the flow of energy to be disconnected from an appliance or other device.

FIG. 4 is a block diagram of one example of a detector module 400, having an 802.11 (i.e., Wi-Fi®) transceiver, and configured to disable the flow of energy to one or more appliances. As shown, the detector module 400 may include a smoke sensor 402, powered by either an AC power source 404 or a battery 406 and a relay/switch 408. Upon the smoke sensor 402 sensing or detecting smoke or products of combustion, the relay/switch 408 may be moveable from an open position, where power is disconnected to an 802.11 (i.e., Wi-Fi®) transceiver 410, and a closed position where power is supplied to the transmitter 410. As discussed above, when power is provided to the transmitter 410, the transmitter 410 may send a signal to a receiver on a valve controller unit (or valve member) for disabling or disconnecting the flow of energy to an appliance or other device.

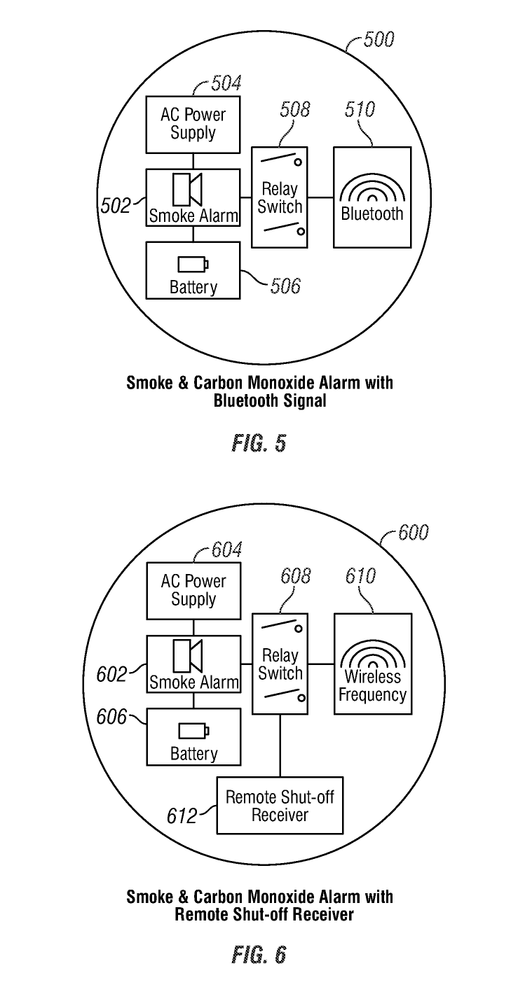

FIG. 5 is a block diagram of one example of a detector module 500, having a Bluetooth transceiver, configured to disable the flow of energy to one or more appliances. As shown, the detector module 500 may include a smoke sensor 502, powered by either an AC power source 504 or a battery 506, and a relay/switch 508. Upon the smoke sensor 502 sensing or detecting smoke or products of combustion, the relay/switch 508 may be moveable from an open position, where power is disconnected to a Bluetooth transceiver 510, and a closed position supplying power to the transmitter 510. As discussed above, when power is provided to the transmitter 510, the transmitter 510 may send a signal to a receiver on a valve controller unit (or valve member) for disabling or disconnecting the flow of energy to an appliance or other device.

FIG. 6 is a block diagram of one example of a detector module 600, having a wireless transceiver and remote shutoff receiver, configured to disable the flow of energy to one or more appliances. As shown, the detector module 600 may include a smoke sensor 602, powered by either an AC power source 604 or a battery 606, and a relay/switch 608. Upon the smoke sensor 602 sensing or detecting smoke or products of combustion, the relay/switch 608 may be moveable from an open position, where power is disconnected to a wireless transceiver 610, and a closed position supplying power to the transmitter 610. As discussed above, when power is provided to the transmitter 610, the transmitter 610 may send a signal to a receiver on a valve controller unit (or valve member) for disabling or disconnecting the flow of energy to an appliance or other device. Additionally, the detector module 600 may include a remote shut off receiver 612 for supplying power to the relay switch 608 remotely and disconnecting the flow of energy to the application or other device, discussed in more detail below.

### Reset Switch

As discussed above, the detection of an audible alert may disable or disconnect the flow of energy to an appliance by causing one or more relays in a valve controller, as discussed in further detail below, to move to an open position. However, if an individual is close or present in the room where the detector is located, it may not be necessary for the flow of energy to be disabled or disconnected. To prevent unnecessary disconnection or disablement of the flow of energy to the appliance or other device, a reset switch assembly may be utilized to reset a shut off valve (or valve member) that has been closed preventing the flow of energy.

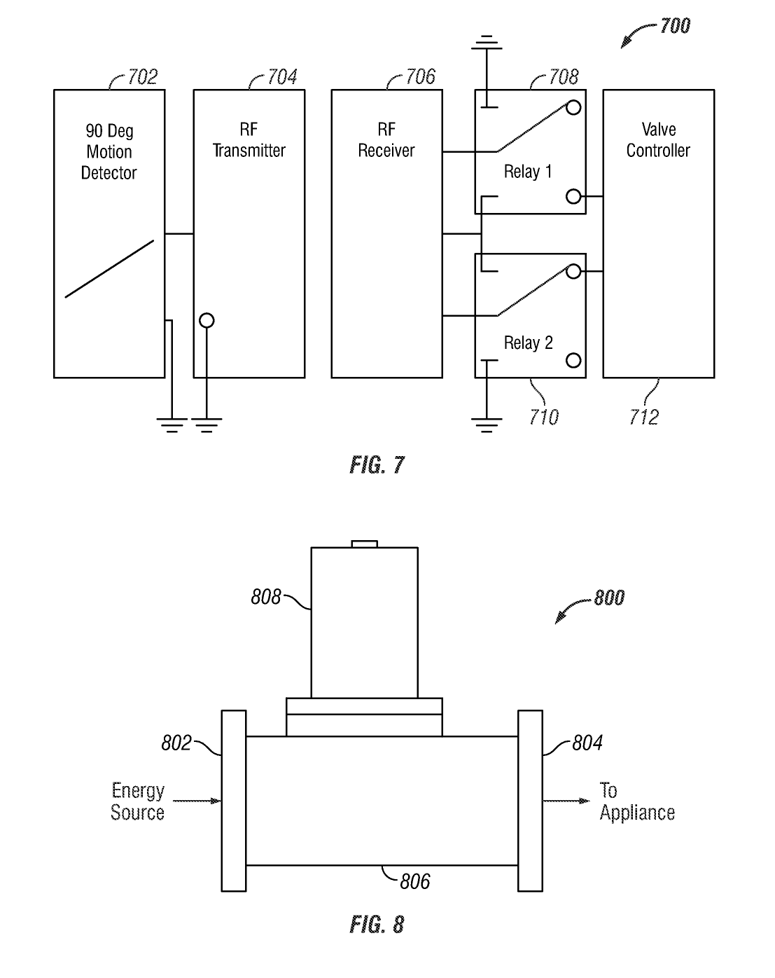

FIG. 7 is a functional block diagram of one example of a reset switch assembly 700 configured to reset a system, for disabling the flow of energy to appliance, after activation. As shown, the reset switch assembly 700 may include a motion detector 702, for sensing the movement or the presence of individuals in a room, communicatively coupled to a transmitter 704. Upon sensing movement or the presence of an individual, the motion detector 702 may cause a signal to be sent, via the transmitter 704, to a receiver 706. The receiver 706 may receive the signal and in turn provide an output signal to one or more relays 708, 710. If the one or more relays 708, 710 are in a closed position, receipt of the output signal may cause the one or more relays 708, 710 to actuate between the closed position and an open position. In other words, each relay may have a switch moveable between a closed position connecting power to a valve controller 712 and an open position disconnecting power to the valve controller 712 as the one or more relays 708, 710 may be operatively connected to the valve controller 712 for controlling the operations of a valve (See FIG. 8) In other words, the reset switch assembly may prevent the flow of energy from being disabled unnecessarily as an individual is present and can extinguish the fire.

FIG. 8 illustrates one example of a valve member 800 for regulating the flow of energy to one or more appliances. The valve member 800 may be connected between an energy source and one or more appliances, or other devices, to control the flow of energy entering the appliance by opening, closing, or partially obstructing various passageways. When in an “open position”, energy may flow to the appliance. Conversely, when in a “closed position”, the energy to the appliance may be interrupted disabling the one or more appliances.

The valve 800 member may comprise a housing defining an inlet port 802 in communication with an energy source, an outlet port 804 in communication with an appliance, and a flow passage 806 between the inlet port and the outlet port. The valve member 800 may include a magnetic coil or solenoid 808 which produces a magnetic field when an electric current is passed through it causing the valve member to open (i.e. open position) allowing the flow of energy to the one or more appliances. Conversely, a lack of an electric current may cause the valve to remain in the “closed position” preventing the flow of energy to the one or more appliance and as a result disabling the one or more appliances or other devices.

### Vibrational Switch

According to one embodiment, a vibration switch may be utilized to determine the occurrence of a significant earthquake. A vibration switch is a device that recognizes the amplitude of the vibration to which it is exposed and provides a response in the form of an output signal when this amplitude exceeds a predetermined threshold value. For example, in the event of a significant earthquake, the vibration switch will recognize that the amplitude of vibrations that it is measuring exceeds a threshold value and sends a signal to a valve controller or other device causing a valve located between an energy source and an appliance to close disabling the flow of energy to the appliance.

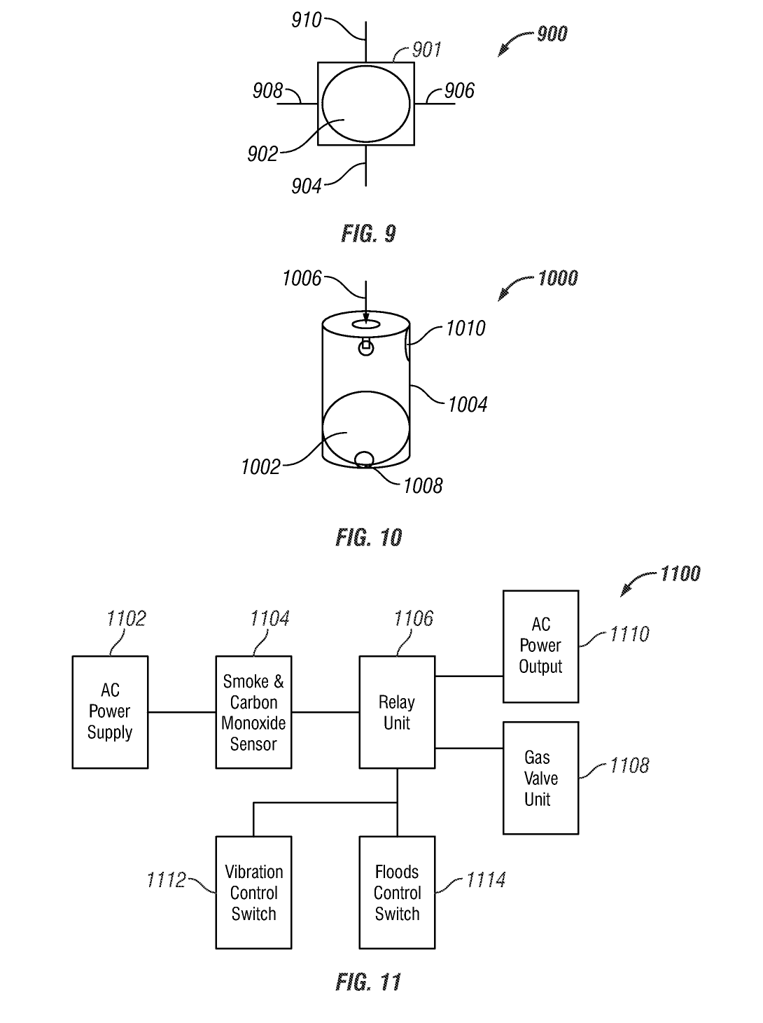

FIG. 9 illustrates one example of a vibration switch 900 for disabling appliances in the event of an earthquake. As shown, the vibration switch 900 may include a ball 902 located within a housing 901. When no vibrations are detected, the ball 902 may connect a first line 904 and a second line 906 together. However, when a vibration exceeding a pre-determined threshold is detected, the ball 902 may move to a different position within the housing causing a connection between different lines. For example, a third line 908 and a fourth line 910 may form a connection or the third line 908 and the first line 904 or the second line 906 and the fourth line 910 may connect. The connected lines may be used to power a relay controlling the flow of energy to an appliance, as described above. According to one embodiment, when the ball 902 moves to different switching position, power to the relay may be interrupted which in turn disables energy or power to the appliance.

### Flood Control Switch

According to one embodiment, a flood control switch may be utilized to prevent the flow of energy to an appliance or other device in the event that there is excessive water present. FIG. 10 illustrates one example of a flood control switch for disabling an appliance or other device. As shown, the flood control switch 1000 may include a ball 1002 located at the center of a canister 1004 which floats to push a switch 1006. Water, or other fluid, may enter the canister 1004 through a water intake hole 1008 located on a side of the canister 1004. As water enters the canister 1004, the ball 1002 is pushed upwards. In the event of excess water, the ball may be pressed against the switch 1006 which in turn may send a signal to a valve controller causing a valve (or valve member), located between an energy source and an appliance, to close disabling the flow of energy to the appliance or other device. The flood control switch may also include a water release hole 1010 allowing water to be released from the canister 1004 if the water recedes.

### Wired System for Disabling an Appliance

FIG. 11 is a functional block diagram of one example of a wired system 1100 for disabling the flow of energy to an appliance in response to an event, according to one embodiment. As described above, upon the occurrence of an event, one or more energy sources may be interrupted or disabled preventing the flow of energy to an appliance or other device rendering them inoperable.

In one example, the system 1100 of FIG. 11 may be used to automatically disable an appliance, such as a gas stove, upon the occurrence of an event. As shown, gas may be supplied to the stove via a gas valve unit 1108 and electricity may be supplied to the stove via an AC power output 1110. That is, the gas valve unit 1108 may be located between a gas output and the stove providing gas to the stove when in an open position. Electricity may be supplied to stove via the AC power output 1110.

As shown, an AC power supply 1102 may provide power to a smoke and carbon monoxide sensor (or detector module) 1104, for example, allowing the sensor to detect the presence of smoke and/or carbon monoxide. The sensor 1104 may be in communication with a relay 1106 operatively coupled to the AC power output 1110 and the gas valve unit 1108. Upon the detection of smoke and/or carbon monoxide, the sensor 1104 may transmit an output signal to the relay 1106 causing the relay 1106 to actuate from a closed position to an open position causing electrical power to be disconnected from the appliance (gas stove) and move the gas valve unit 1108 to a closed position disabling the flow of gas to the stove. Disabling the gas and electricity from the stove may prevent a fire from occurring or lessen the damage in the event a fire has already broken out.

The system 1100 may also include a vibration control switch 1112 and/or a flood control switch 1114, as described above, operatively coupled to the relay 1106. Upon the detection of an earthquake and/or the presence an excessive amount of water, the vibration control switch 1112 and/or the flood control switch 1114 may transmit an output signal to the relay 1106 causing the relay 1106 to actuate from a closed position to an open position disabling electrical power to the appliance (gas stove) and move the gas valve unit 1108 to a closed position disabling the flow of gas to the stove. As discussed above, disabling the gas and electricity to the stove may prevent a fire from occurring or lessen the damage in the event a fire has already broken out.

### Remote Shut-Off

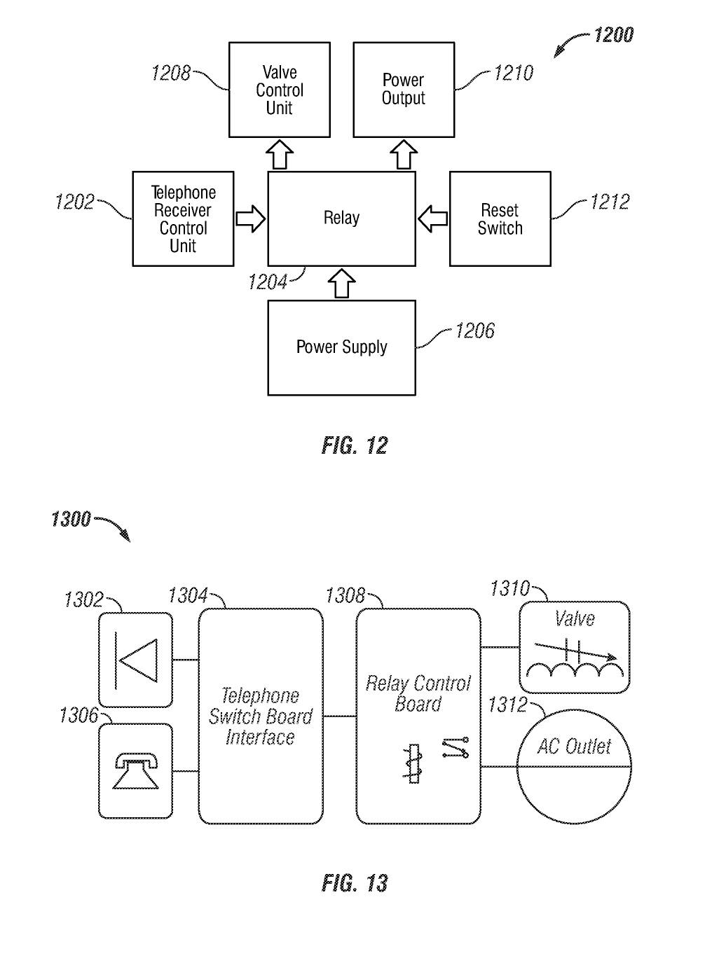

According to one embodiment of the present invention, a user may remotely control the flow of energy to one or more appliances or devices. FIG. 12 is a functional block diagram of one example of a system 1200 for remotely controlling the flow of energy to one or more appliances. If a user or individual is away from the home and wishes to disable one or more appliances by disabling the flow of energy powering the appliances, the user may utilize a telephone or computer to cut off the flow of energy. The user may seek to disable the appliances for many reasons, including but not limited to, leaving for an extended period of time or the occurrence of an act of GOD, such as an earthquake, flood or fire.

To disable the appliances, the user may log on to website or call a specified number, which is in communication with a receiver control unit 1202, and enter a code. The receiver control unit 1202 may be part of a central computer, as described above with reference to FIG. 1B. Upon receiving instructions, in the form of a code, for example, from the user to interrupt for disable the flow of energy to the appliance, the receiver control unit 1202 may send an output signal to a relay (or relay control board) 1204. The relay 1204 may be operatively coupled to a valve control unit 1208 and power output 1210 which are used to control the flow of energy to the appliances. After receiving instructions to disable the appliances, the relay 1204 may actuate from a closed position, allowing the flow of energy to the appliances, to an open position, interrupting or disabling the flow of energy to the appliances, or other devices, rendering the appliances inoperable.

The system 1200 may include a reset switch 1212 operatively coupled to the relay 1204 for re-engaging the flow of energy to the appliances by causing the relay 1204 to actuate from an open position, after the system has been activated, to a closed position. When in the closed position, power is supplied to the valve control unit enabling the flow of energy to the appliances.

FIG. 13 is another functional diagram of a remote shut-off system for remotely controlling the flow of energy to one or more appliances, according to one embodiment. As shown, a main telephone line 1302 may be an input into a telephone switch board interface 1304. Upon receiving a call, the telephone switch board interface 1304 may automatically connect the call to a receiver 1306, such as a telephone. If the telephone is not answered within a pre-determined number of rings, the telephone switch board interface 1304 may request a code from the caller, the code allowing the caller to disable the flow of energy to the one or more appliances or other devices. The pre-determined number of rings may be pre-programmed into the system, or the user or caller may set the number of unanswered rings to occur before the code is requested.

Upon entering a code, the code is compared to the value stored in memory. If the entered code and the stored code match, the telephone switch board interface 1304 may cause a relay 1306 to actuate from a closed position allowing the flow of energy to an appliance to an open position interrupting or disabling the flow of energy to the appliance. When the relay is in the open position, a valve 1310, such as a gas valve, is closed preventing gas from reaching the application. Additionally, when the relay is in the open position, electrical power 1312 to the application may be cut off or interrupted.

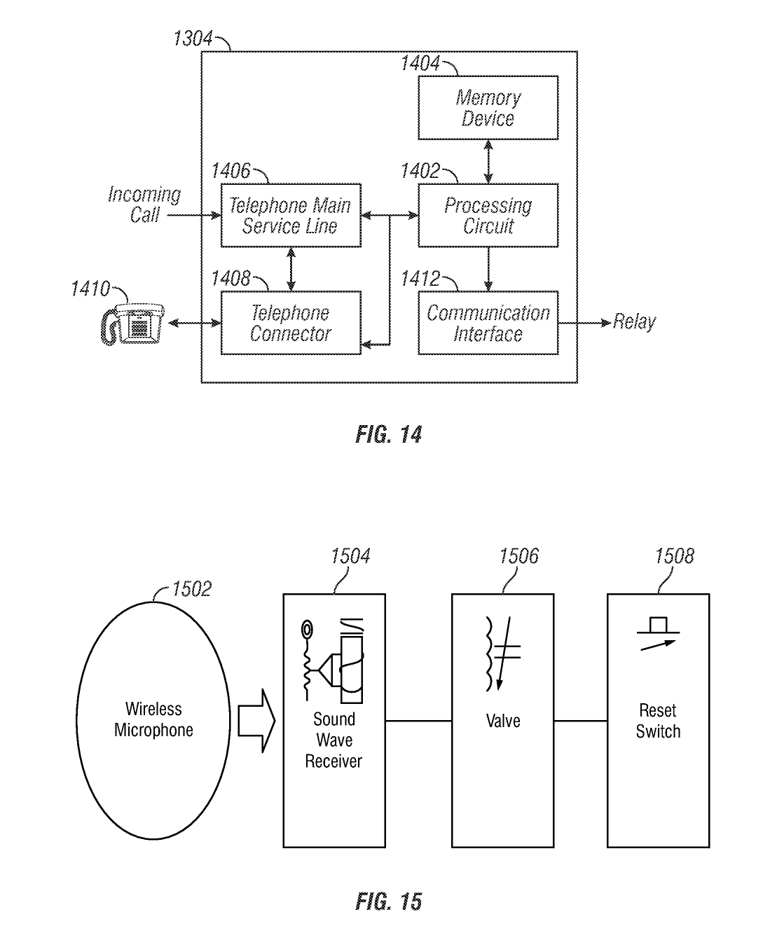

FIG. 14 illustrates a functional block diagram of the internal structure of the telephone switch interface board of FIG. 13. The telephone switch interface board 1304 may include a processing circuit 1402 (e.g., processor, processing module, etc.) coupled to a communication interface 1412 to communicate over a wired and wireless network with a relay, and a memory device 1404 to store codes associated with each appliance allowing the user to turn off a specific appliance or multiple appliances. The processing circuit 1402 may be connected to a telephone main service line 1406 for receiving incoming calls and a telephone connector 1408 in communication with a telephone 1410.

### Sound Wave Receiver Valve

FIG. 15 is a functional block diagram of one example of a wireless sound wave valve having a reset switch, according to one embodiment of the present invention. As shown, a wireless microphone 1502 (or directional sound receiver) may receive sound waves which are provided to a sound wave receiver 1504. The sound wave receiver 1504 may determine if any of the received sound waves include any high pitch sounds or alarm.

The determination of the receipt of high pitch sound waves may trigger a single pole double throw (SPDT) relay, located within the receiver 1504, to actuate from a closed position to an open position causing power to be to cut-off or interrupted to a valve (or valve member) 1506 which regulates the flow of energy to the appliance or other device. When power to the valve (or valve member) 1506 is interrupted, a magnetic coil in the valve releases a lock rod causing the lock rod to disable or interrupt the flow of energy, such as gas, to the appliance. A push button switch 1508, operatively coupled to the valve (or valve member) 1506, may be manually pushed causing the valve to move from the closed position to the open position by re-engaging power to the valve (or valve member) 1506 and allowing energy to again flow to the appliance or other device.

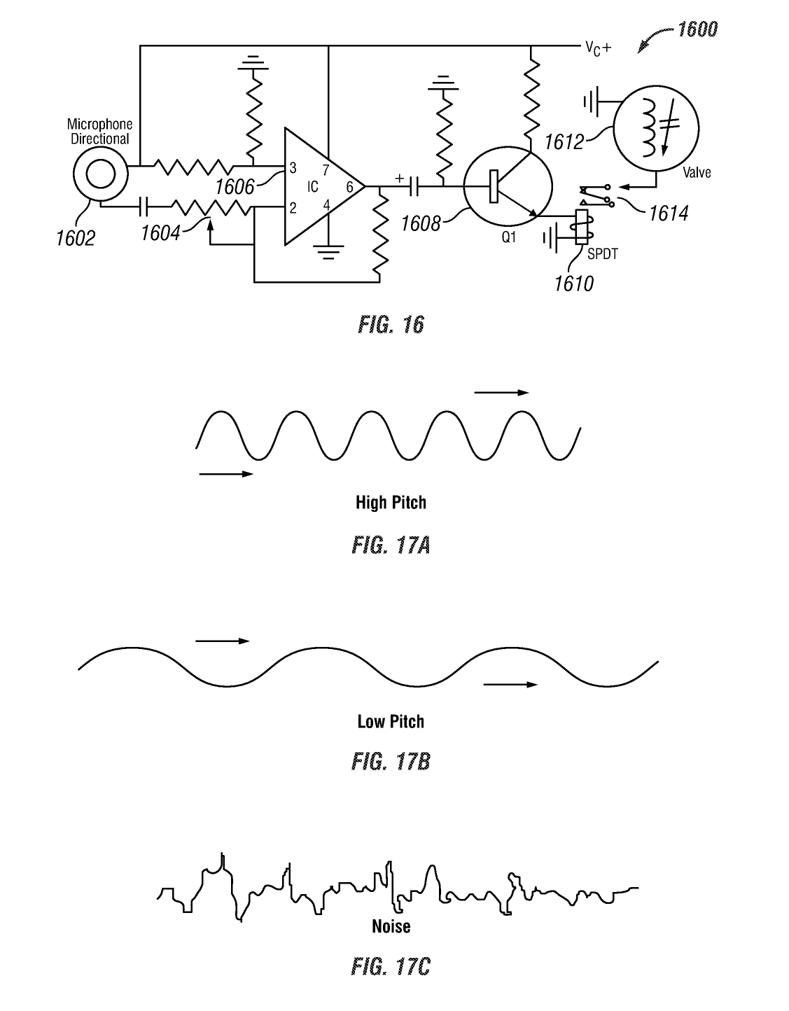

FIG. 16 illustrates a schematic diagram of the sound wave valve of FIG. 15. As shown, a directional microphone 1602 may receive sound waves, including high pitch audible sounds, which are transmitted to a trimmer resistor 1604 for filtering and controlling wave gains. The filtered sound waves may then be transmitted from the trimmer resistor (or potentiometer) 1604 to an operational amplifier 1606 for amplification. The amplified sound waves may then be transmitted to a transistor 1608 for measuring the stable frequency of the sound waves and powering on a single pole double throw (SPDT) relay 1610. If there is a variation in the frequency, or a Doppler Effect, of the sound waves, the transistor 1608 may provide power to the SPDT relay 1610 causing the SPDT relay 1610 to actuate from a closed position to an open position causing power to be to cut-off or interrupted to a valve (or valve member) 1612 causing the disconnection of the flow of energy to the appliance or other device. Conversely, when the SPDT relay 1610 is not powered-on and in the closed position, power may be supplied to the valve (or valve member) 1612 causing energy to flow to the appliance or other device.

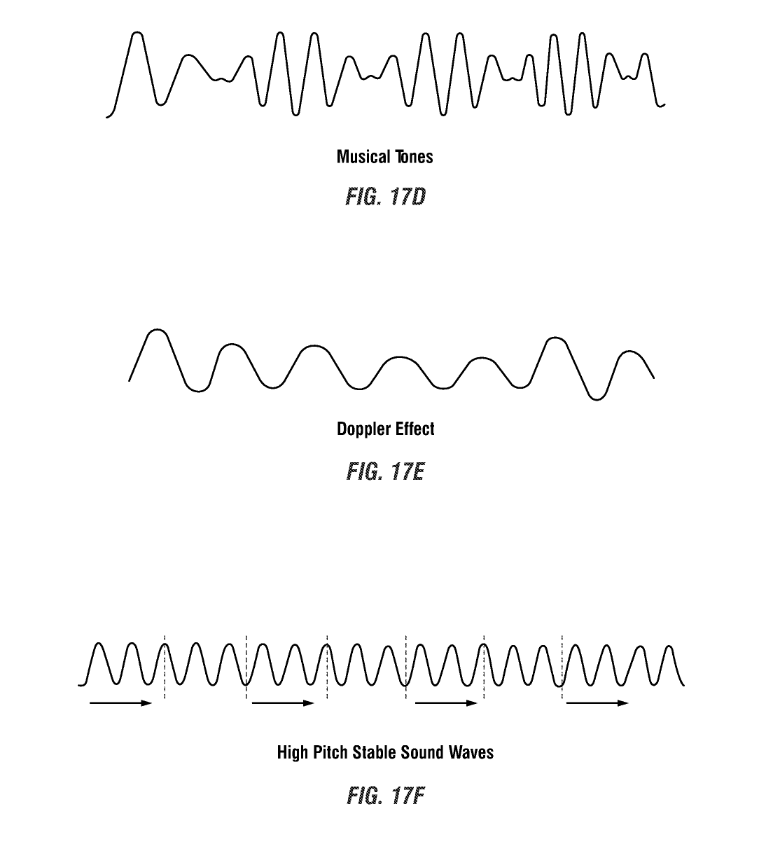

FIGS. 17A-17F illustrate various diagrams of sound waves which may be received by the sound wave receiver of FIG. 15. As discussed above, the sound wave receiver may be activated upon the receipt of a stationary high pitch (high frequency) sound wave as shown in FIG. 17A. One characteristic of stable high frequency sound waves may be that the source and receiver of the sound remain stationary so that the receiver will hear the same frequency sound produced by the source. This is because the receiver is receiving the same number of waves per second that the source is producing. As a result, any stationary audible sounds, such as fixed fire and smoke alarms, will result in characteristics of stationary stable high frequency waves. Upon receipt of a stationary high pitch sound wave, the flow of energy to the appliance or other device may be disconnected or interrupted. Conversely, the receipt of a non-stationary high pitch sound wave disconnects or interrupts the flow of energy to the appliance or device.

A low pitch sound wave (See FIG. 17B), a sound wave in the form of noise (See FIG. 17C) and a mixture of different sound, such as music tones (See FIG. 17D), for example, may not be sufficient to activate the sound wave valve. Sound waves in the form of noise have no tonal quality as it distracts and distorts the sound quality that was intended to be heard. Generally noise is an unwanted disturbance caused by spurious waves originating from different sources. As a result, disturbed high pitch sounds found in noise are not enough to activate the sound wave valve.

Detection of a Doppler Effect in a sound wave may be utilized to determine if the sound wave valve is to be activated. A sound wave with a Doppler Effect is shown in FIG. 17E. A Doppler Effect is the apparent change in frequency or pitch when a sound source moves either toward or away from the listener, or when the listener moves either toward or away from the sound source. If either the source or the receiver or both move toward the other, the receiver will perceive a higher frequency sound. If the source and the sound wave receiver are moving apart, the receiver will receive a smaller number of sound waves per second and will perceive a lower frequency sound. For example, the frequency of a Police Siren on a fast-moving police car increases in pitch as the Police Car is approaching. Although the Siren is generating high pitch sound waves, the wave is not stable when it is in motion and, as a result, the sound waves will fail to activate the sound wave valve.

As discussed above, a stationary high frequency sound wave, as shown in FIG. 17F, may be utilized to activate the sound wave valve. For example, a fire alarm or smoke detector fixed inside the house may emit a stationary high frequency sound wave activating the sound wave valve. That is, if no change in the pitch or frequency of the sound wave and formation are detected, the sound wave receiver may cut-off the power supply to the valve and the electrical source resulting in the disablement of the appliance or other device by restricting the flow of energy. According to one aspect, any stationary sources of sound waves having high frequency, such as a continuous, stationary, whistle blowing without motion may generate a constant high pitch causing power to be disconnected from the valve (or valve member).

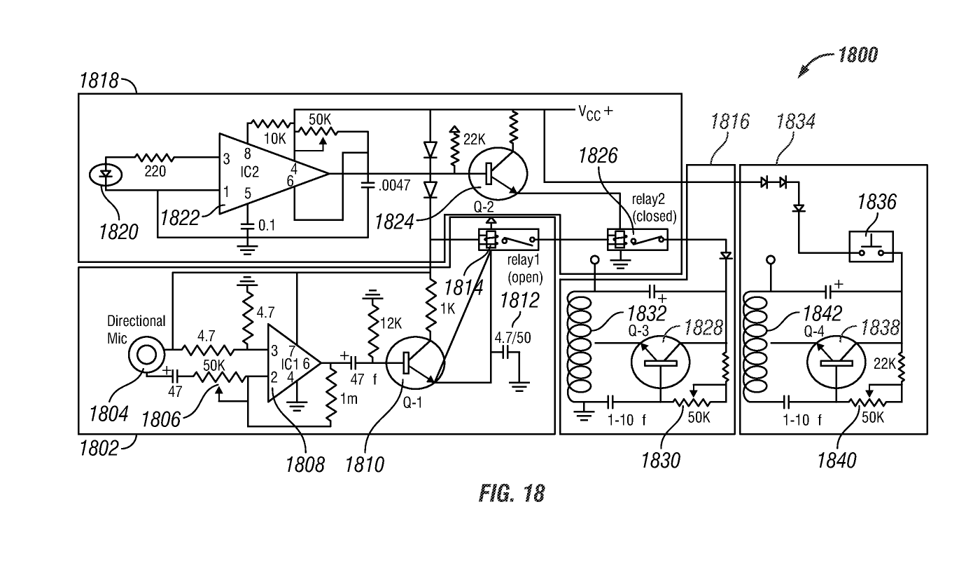

FIG. 18 illustrates a schematic diagram 1800 of a sound wave receiver having a motion detector and wireless switches, according to one embodiment of the present invention. As shown, the sound wave receiver may include a sound wave receiver module 1802, a passive infrared (PIR) motion detector module 1818, a first wireless transmitter module 1816 and a second wireless transmitter module 1834.

The sound wave receiver module 1802 may include a directional microphone 1804 for receiving high pitch audible sounds which are then transmitted to a trimmer resistor (i.e. potentiometer or variable resister) 1806 for filtering and controlling wave gains. The filtered sound wave may be transmitted from the trimmer resistor (potentiometer) 1806 to an operational amplifier 1808 for amplification. The amplified sound waves may then be transmitted to a transistor, such as BC337, 1810 for measuring the stable frequency of the sound waves. The stable high frequency or pitch may then provide constant current to a capacitor 1812 for powering on a single pole double throw (SPDT) relay 1814. If there is a variation, or a Doppler Effect, of the sound waves, the transistor 1810 may provide power to the SPDT relay 1814 causing the SPDT relay 1814 to actuate from an open position to a closed position supplying power to the valve allowing energy to flow to the appliance or other device. Conversely, when the SPDT relay 1814 is not supplied with power, the relay 1814 is in the open position resulting in disconnecting or interrupting the flow of energy to the appliance or other device.

The PIR motion detector module 1818 may block the operation of the sound wave receiver. The PIR motion detector module 1818 may include a PR motion detector 1820 for sensing the presence of an individual by continuous movement in an area within a predetermined distance, for example eight (8) feet from the sound wave receiver reset switch. Upon the detection of the presence of an individual, a signal may be sent to a timing device 1822, such as an astable timer, which in turn may send a continuous stream of rectangular pulses having a specified frequency to a transistor 1824 providing power to the transistor 1824. The transistor 1824 may then provide power to a normally open signal pole relay switch 1826 activating the switch to cut off or interrupt power between the sound receiver and the first wireless transmitter module 1816. Consequently, as long as the PIR motion detector 1820 detects continuous movement within the pre-determined distance from the sound wave receiver reset switch, the first wireless transmitter cannot disrupt gas and electricity to the appliance, even if the sound wave receiver detects the presence of stationary high pitch sound waves from a smoke detector or fire alarm.

The first wireless transmitter module 1816 may include a transistor 1828, a variable resistor (or potentiometer) 1830 and an antenna coil 1832. The first wireless transmitter module 1816 may be activated upon acknowledgement, by the sound wave receiver, of a constant, stationary high pitch (or frequency) sound wave which is unblocked by the PIR motion detector 1820. Once activated, a transistor or high frequency amplifier 1828 may distribute the signal to a variable resistor (or potentiometer) 1830, for trimming the frequency, and the antenna coil 1832.

The second wireless transmitter module 1834 may be used to adjust the medium of the antenna coil 1832 to a different level of frequency to avoid similar wireless signal distribution. The second wireless transmitter module 1834 may include a push button switch 1836 for the valve and electrical assembly, a NPN transistor high frequency amplifier 1838, a variable resistor (or potentiometer) 1840 and a second antenna coil 1842. Upon activation of the push button switch 1836, power may be provided to a NPN transistor high frequency amplifier 1838 causing the distribution of the signal to the variable resistor 1840 for trimming the frequency and the second antenna coil 1842 to commence the wireless communication with the valve reset unit.

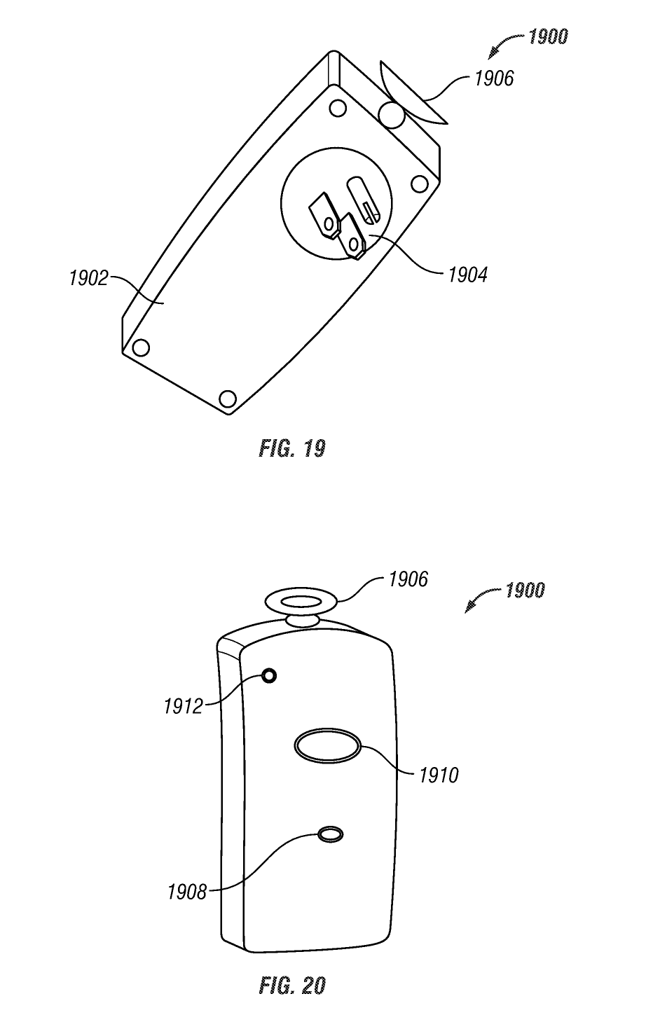

As discussed above, sound waves may be utilized to disable an appliance, or other device, in the event of an emergency. FIGS. 19-20 illustrate back and front views, respectively, of a sound wave receiver 1900, according to one aspect of the present invention. The sound wave receiver 1900 may be in operative communication with a shut off valve which regulates the flow of energy to an appliance or other device. As shown, the sound wave receiver 1900 may include a housing 1902 having an electrical plug 1904 for plugging into an outlet for supplying power to the receiver 1900, a microphone 1906 for receiving sound waves, a motion detector 1908 for determining the presence of a person and a reset switch 1910 for manual resetting or re-initialization of the shut off valve after activation.

Upon receiving stationary high pitch sound waves, as discussed above, and failing to detect the presence of continuous motion, the receiver 1900 may cause the shut off valve (or sound wave valve or valve member) to shut off the flow of energy to the appliance or other device. As the appliance is no longer receiving energy, the appliance may be disabled. If the presence of a person (i.e. continuous motion) is detected, the receiver 1900 may not cause the valve to disable or interrupt the flow of energy to the appliance as a person has been detected and that person may manually disable the appliance. The receiver may also include a light 1912 for indicating the status of the receiver or valve. That is, the light 1912 may indicate if the valve has shut off the appliance and requires resetting or re-initialization. The sound wave receiver 1900 may or may not be located in the same room as the appliance.

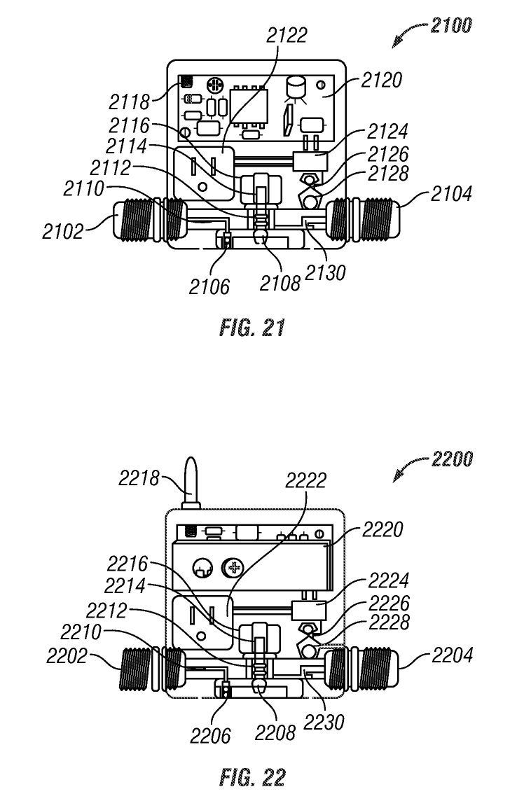

FIG. 21 illustrates a front view of a wired sound wave valve 2100, according to one embodiment of the present invention. The valve 2100 may include an inlet port or connector 2102 for connection with an energy source, such as gas, and an outlet port or connector 2104 for connection with the appliance, or other device. A microphone 2118, located on a printed circuit board (PCB) 2120 may be activated by receiving any high pitch sounds or alarm within its frequency range. Once activated, the microphone 2118 may trigger a single pole double throw (SPDT) relay 2124 causing power to be to cut-off to the valve.

The gas may flow through the inlet port 2102 to a tube 2110 in communication with a pressure regulator 2106 for automatically cutting off the flow of gas at a certain pressure. As long as the gas has not reached an unsafe pressure, gas flows into a gas flow chamber 2108.

The valve 2100 may include a magnetic coil or solenoid 2116 which produces a magnetic field when an electric current is passed through it causing the valve to open allowing gas to pass through the outlet port 2104 to the appliance. The solenoid may be in operative communication with a control valve lock spring 2112 to selectively operate the solenoid 2116. The solenoid 2116 may control the release of a lock rod 2114 which is used to block the flow of gas from the inlet port to the outlet port by preventing the gas from flowing from the gas input tube through the gas flow chamber to the gas output tube 2130.

The wired sound wave valve 2100 may also include an electric current outlet 2122 for plugging in a power source for the appliance. A single pole double throw (SPDT) relay 2124 may be in communication with a vibration switch 2126 and a flood control switch 2128. The vibration switch 2126 and the flood control switch 2128 may be utilized to detect an earthquake and/or a flood. Upon the detection of an earthquake or flood, gas and power may be disabled to the appliance.

FIG. 22 illustrates a front view of a wired sound wave valve 2200, according to one embodiment of the present invention. The valve 2200 may include an inlet port or connector 2202 for connection with an energy source, such as gas, and an outlet port or connector 2204 for connection with the appliance, or other device. An antenna 2218, in communication with a wireless switch 2220, may receive stationary high pitch sounds or alarms within its frequency range. Once received, the switch may trigger a single pole double throw (SPDT) relay 2224 causing power to be to cut-off to the valve.

The gas may flow through the inlet port 2202 to a tube 2210 in communication with a pressure regulator 2206 for automatically cutting off the flow of gas at a certain pressure. As long as the gas has not reached an unsafe pressure, gas flows into a gas flow chamber 2208

The valve 2200 may include a magnetic coil or solenoid 2216 which produces a magnetic field when an electric current is passed through it causing the valve to open allowing gas to pass through the outlet port 2204 to the appliance. The solenoid may be in operative communication with a control valve lock spring 2212 to selectively operate the solenoid 2216. The solenoid 2216 may control the release of a lock rod 2214 which is used to block the flow of gas from the inlet port to the outlet port by preventing the gas from flowing from the gas input tube through the gas flow chamber to the gas output tube 2230.

The wireless sound wave valve 2200 may also include an electric current outlet 2222 for plugging in a power source for the appliance. The single pole double throw (SPDT) relay 2224 may be in communication with a vibration switch 2226 and a flood control switch 2228. The vibration switch 2226 and the flood control switch 2228 may be utilized to detect an earthquake and/or a flood. Upon the detection of an earthquake or flood, gas and power may be disabled to the appliance.

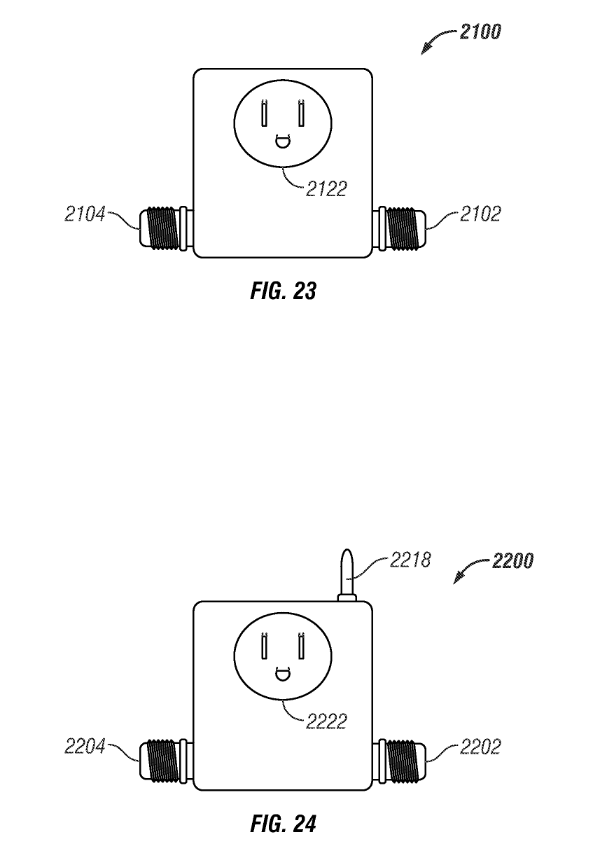

FIGS. 23-24 illustrate front views, respectively, of the wired and wireless sound wave valves of FIG. 21 and FIG. 22, respectively.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A system for automatically disabling appliances, comprising:
one or more detectors configured to emit a signal upon an occurrence of an event, the signal in the form of sound waves;
a receiver module configured to receive a plurality of sound waves and analyze the plurality of sound waves for a variation in frequency to determine if any of the plurality of the sound waves originate from the one or more detectors; and
a valve member, in communication with the receiver module, having a first port connected to an energy source and a second port connected to one or more appliances, the valve member operable between a first position where the energy source provides energy to the one or more appliances and a second position where the energy source is disconnected disabling the one or more appliances, and where the valve member actuates from the first position to the second position in response to a determination of the sound waves originating from the one or more detectors.

2. The system of claim 1, wherein the receiver module comprises:
a microphone for receiving the plurality of sound waves;
a variable resistor for receiving the plurality of sound waves received from the microphone and generating a plurality of constant sound waves;
an amplifier for receiving and amplifying the plurality of constant sound waves output from the variable resistor;
a transistor for receiving the amplified plurality of constant sound waves from the amplifier; and
a relay, connected between the transistor and a power source, supplying power to the relay, the relay controlling actuation of the valve member between the first position and the second position.

3. The system of claim 1, wherein an occurrence of a Doppler Effect in the plurality of sound waves indicates that the plurality of sound waves emanate from a source different from the one or more detectors.

5. The system of claim 2, wherein power to the valve member is disabled when the relay is powered on.

6. The system of claim 2, further comprising a reset switch in communication with the valve member for re-engaging the power to the valve member.

7. The system of claim 1, further comprising a motion detector, in communication with the receiver module, for detecting continuous movement within a pre-determined distance of the receiver module, and wherein the detection of continuous motion disables the receiver module and prevents the valve member from moving from the first position to the second position.

8. The system of claim 1, wherein upon the determination of any of the plurality of the sound waves originating from the one or more detectors, the receiver module sends a notification message to a user notifying the user of the occurrence of the event.

9. The system of claim 1, wherein the event includes detection of at least one of a fire, smoke, carbon monoxide.

10. The system of claim 1, wherein the one or more detectors includes at least one of a smoke detector, a carbon monoxide detector, a fire detector, a flame detector and a heat detector.

11. The system of claim 1, wherein the one or more appliances includes at least one of a gas stove, an electric stove, a gas furnace, an electric furnace, a microwave oven, a computer and a television.

12. The system of claim 1, wherein the energy sources includes at least one of gas and electricity.

13. A system for automatically disabling appliances, comprising:
a plurality of detectors configured to emit a signal upon an occurrence of an event, the signal in the form of sound waves;
a plurality of receiver modules configured to receive a plurality of sound waves and analyze the plurality of sound waves for a variation in frequency to determine if any of the plurality of the sound waves originate from the plurality of detectors; and
a plurality of valve members in communication with the plurality of receiver modules, each valve member of the plurality of valve members having a first port connected to an energy source and a second port connected to one or more appliances, the valve member operable between a first position where the energy source provides energy to the one or more appliances and a second position where the energy source is disconnected disabling the one or more appliances and where the valve member actuates from the first position to the second position in response to a determination of the plurality sound waves originating from the plurality of detectors; and
a motion detector, in communication with the plurality of receiver module, for detecting continuous movement within a pre-determined distance of the receiver module, where the detection of continuous motion disables at least one of the plurality of receiver module and prevents the at least one of the plurality of valve members from moving from the first position to the second position.

14. The system of claim 13, further comprising a central computer in communication with the plurality of receiver modules, wherein the central computer, in response to receiving the signal from at least one of the plurality of receiver modules, sends a message to at least one of the plurality of valve members causing the at least one of the plurality of valve members to actuate from the first position to the second position.

15. The system of claim 14, wherein the central computer comprises:
a communication interface for receiving an access input code;
a memory device for storing a list of appliance codes; and
a processing circuit coupled between the communication interface and the memory device, the processing circuit configured to:
receive the access input code, the access input code provided remotely;
compare the access input code to a list of appliance codes stored in the memory device;
send the message to the at least one of the plurality of valve members causing the at least one of the plurality of valve members to actuate from the first position to the second position disabling an appliance in communication with the at least one of the plurality of valve members.

16. The system of claim 15, wherein the access input code is provided remotely by entering the access input code via a website or via a telephone.

17. The system of claim 13, wherein upon the determination of any of the plurality of the sound waves originating from the one or more detectors, the receiver module sends a notification message to a user notifying the user of the occurrence of the event.

18. The system of claim 13, wherein each of the plurality of receiving modules comprises:
a microphone for receiving the plurality of sound waves;
a variable resistor for receiving the plurality of sound waves received from the microphone and generating a plurality of constant sound waves;
an amplifier for receiving and amplifying the plurality of constant sound waves output from the variable resistor;
a transistor for receiving the amplified plurality of constant sound waves from the amplifier; and
a relay, connected between the transistor and a power source, supplying power to the relay, the relay controlling actuation of the valve member between the first position and the second position.

19. The system of claim 13, wherein an occurrence of a Doppler Effect in the plurality of sound waves indicates that the plurality of sound waves emanate from a source different from the one or more detectors.

20. The system of claim 13, further comprising a reset switch in communication with the valve member for re-engaging the power to the valve member.
